(19) United States
(12) Patent Application Publication
(10) Pub. No.: US 2024/0124333 A1
(43) Pub. Date: Apr. 18, 2024

(54) METHOD FOR CONTROLLING RO SYSTEM

(71) Applicants: KURITA WATER INDUSTRIES LTD., Tokyo (JP); Fracta Leap K.K., Tokyo (JP)

(72) Inventor: Shuhei HATORI, Tokyo (JP)

(73) Assignees: KURITA WATER INDUSTRIES LTD., Tokyo (JP); Fracta Leap K.K., Tokyo (JP)

(21) Appl. No.: 18/277,580

(22) PCT Filed: Feb. 24, 2022
(86) PCT No.: PCT/JP2022/007595

§ 371 Date: Aug. 16, 2023

(30) Foreign Application Priority Data
Feb. 26, 2021 (JP) 2021-030480

(51) Int. Cl. C02F 1/44; B01D 61/02; B01D 61/12; B01D 65/08

(52) U.S. Cl. CPC C02F 1/441; B01D 61/026; B01D 61/12; B01D 65/08; B01D 2313/70; B01D 2321/20; B01D 2321/40; C02F 2209/005; C02F 2209/44

(57) ABSTRACT

There is provided a method for controlling an RO system, the method being capable of reducing power consumption (that is, CO2) and the amount of waste by reducing the amount of use of chemicals and the number of times of exchanging a membrane and capable of enabling stable operation and contributing to energy saving. A method for controlling an RO system, the RO system including a plurality of RO apparatuses 41 to 44 arranged in parallel and a control unit controlling a start/stop process, the start/stop process including an operation process and a stop process for the RO apparatuses 41 to 44, wherein control is performed so that the number of times of start/stop is larger for an RO apparatus that easily recovers treatability by start/stop.

### TECHNICAL FIELD

The present invention relates to a method for controlling an RO system for performing reverse osmosis treatment of water, and in particular to a method for controlling an RO system including a plurality of RO apparatuses installed in parallel.

### BACKGROUND ART

When fouling occurs on an RO (reverse osmosis) membrane, feed-water pressure increases, and power consumption of a feed-water pump increases. Therefore, chemical cleaning may be performed to reject the fouling. Chemical cleaning, however, requires time and costs, and, moreover, deteriorates the membrane and shortens the life of the membrane.

Chemical cleaning targets especially organic fouling and microbial (bio) fouling. On an RO membrane, physical fouling such as SS fouling due to SS (suspended solids) may also occur.

Therefore, it is desirable to be able to, while reducing the number of times of chemical cleaning as far as possible, prevent fouling on an RO membrane with a simple configuration and ensure the treatment efficiency of a water treatment system.

As an anti-clogging method for an RO apparatus with an RO membrane, PTL1 describes a method of blowing suspended solid concentrated effluent water that has occurred on a reverse osmosis membrane part in a process of filtering water to be treated, at regular intervals of accumulated water-passing time.

PTL2 describes that, based on degrees of membrane clogging, priority of filtering apparatuses to be caused to operate, among a plurality filtering apparatuses arranged in parallel, is set. In the paragraph of 0064 of PTL2, it is described to air-clean a membrane.

### CITATION LIST

### Patent Literature

PTL1: JP 2005-279461A
PTL2: JP 2016-067968A

### SUMMARY OF INVENTION

### Problem to be Solved by the Invention

A subject of the present invention is to provide a method for controlling an RO system, the method being capable of reducing power consumption and the amount of waste by reducing the amount of use of chemicals and the number of times of exchanging a membrane and capable of enabling stable operation and contributing to energy saving.

### Solution to Problem

A method for controlling an RO system of the present invention is a method for controlling an RO system, the RO system comprising a plurality of RO apparatuses arranged in parallel and a control unit controlling a start/stop process, the start/stop process including an operation process and a stop process for the RO apparatuses, wherein control is performed so that the number of times of start/stop is larger for an RO apparatus that easily recovers treatability by start/stop.

In one aspect of the present invention, start/stop process histories of the RO apparatuses are stored; and priority of RO apparatuses to be caused to operate, among the RO apparatuses, is decided based on the start/stop process histories.

In one aspect of the present invention, membrane treatment performance histories of the RO apparatuses are stored in association with the start/stop process histories of the RO apparatuses; and a degree of recovery of membrane treatment performance expected due to the start/stop process is estimated for each of the RO apparatuses, based on the start/stop process histories and the membrane treatment performance histories; and an RO apparatus in which the degree of recovery expected due to the start/stop process is higher, among the RO apparatuses, is decided to be prioritized higher.

In one aspect of the present invention, exit pressure or power consumption of a feed-water pump is measured, the feed-water pump feeding water to the RO apparatuses; and an RO apparatus in which the exit pressure or the power consumption is higher, among the RO apparatuses, is decided to be prioritized higher.

In one aspect of the present invention, the number of times of the start/stop process during operation is decided based on a result of the estimation of start/stop effectiveness; and the number of times of start/stop within a predetermined time is decided so that a number-of-times-of-start/stop effect is higher.

In one aspect of the present invention, the membrane treatment performance of each of the RO apparatuses at a current time point is measured; and the priority of the RO apparatuses is decided based on the membrane treatment performance at the current time point.

A program of one aspect of the present invention, is a control program for controlling a water treatment system, the water treatment system comprising a plurality of RO apparatuses arranged in parallel, the program causing a computer to execute: a control instruction to control a start/stop process, the start/stop process including an operation process and a stop process for the RO apparatuses; a storage instruction to store start/stop process histories of the RO apparatuses; and a priority decision instruction to decide priority RO apparatuses to be caused to operate, among the RO apparatuses, based on the start/stop process histories.

### Advantageous Effects of Invention

According to the present invention, it is possible to ensure treatment efficiency of an RO system with a simple configuration. In the present invention, rejection of fouling is performed by performing stop and operation of RO membrane apparatuses or performing flow rate adjustment of each flow path without performing chemical cleaning. Therefore, it is possible to reject fouling by software without adding a special hardware configuration, and the configuration is simple.

Moreover, since fouling is rejected even in start/stop operations included in an operation plan, it is possible to, by planning a start/stop process in consideration of histories of start/stop operations performed in the operation plan, reduce the number of times of treatment related to fouling rejection and efficiently reject fouling, in comparison with PTL1 in which blow treatment is intentionally performed.

### BRIEF DESCRIPTION OF DRAWINGS

FIG. 1 is a system diagram of an RO system to which a control method according to an embodiment is applied.

FIG. 2 is a flowchart showing a flow of determination based on functional blocks.

FIG. 3 is a flowchart showing a flow of determination based on functional blocks.

FIG. 4 is a flowchart showing a flow of determination based on functional blocks.

### DESCRIPTION OF EMBODIMENT

An embodiment will be described below with reference to drawings.

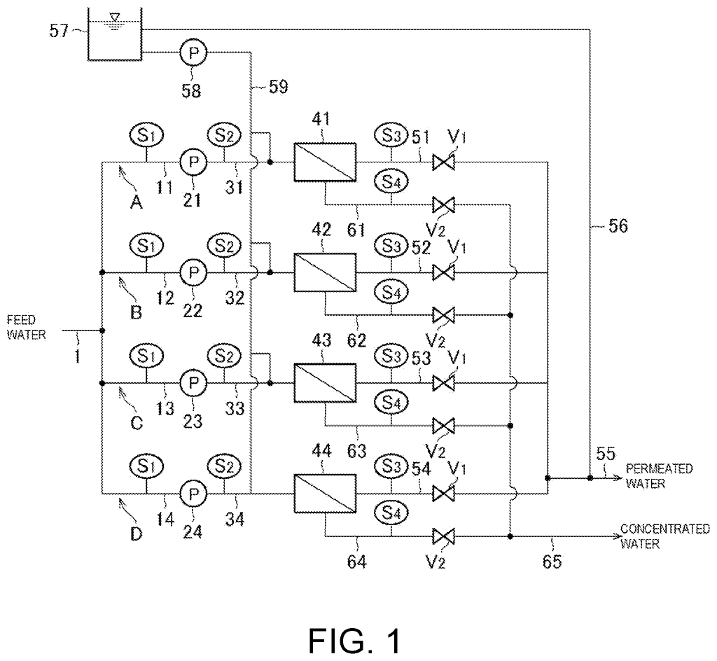

FIG. 1 is a system diagram of an RO system to which a control method according to the embodiment is applied.

Feed water is fed from a feed water pipe 1 to a plurality of (in this embodiment, four) treatment systems (which may be hereinafter referred to as systems) A, B, C, and D and is RO-treated.

In the systems A to D, the feed water is sent by pipes 11 to 14 connected to the feed water pipe 1, and fed to cross-flow type RO apparatuses 41 to 44 by feed-water pipes 31 and 34 after being pressurized by pumps 21 to 24.

Permeated water that has permeated RO membranes of the RO apparatuses 41 to 44 is taken out as permeated water from permeated water pipes 51 to 54 via a collective permeated-water pipe 55. A part of the permeated water is sent to a cleaning water tank 57 via a pipe 56 branched from the collective permeated-water pipe 55 and stored. Water in the cleaning water tank 57 can be supplied to the feed-water pipes 31 and 34 via a cleaning line 59 having a cleaning pump 58.

Concentrated water (brine) of the RO apparatuses 41 to 44 is taken out as concentrated water from concentrated water pipes 61 to 64 via a collective concentrated water pipe 65.

Each of the pipes 11 to 14, and 31 to 34 is provided with sensors S1 and S2 for measuring a flow rate or pressure, and, furthermore, pH and the like. Each of the pipes 51 to 54, and 61 to 64 is provided with sensors S3 and S4 for measuring one or more characteristics such as a flow rate, pressure, electrical conductivity, and the like. Each of the pipes 51 to 54, and 61 to 64 is provided with valves V1 and V2.

Detection data of each sensor is inputted to a control apparatus (not shown). In a memory of the control apparatus, operation plan data is stored together with a control program. Each of the pumps 21 to 24, and 58 and the valves V1 and V2 is controlled according to a signal from the control apparatus.

In the present embodiment, short-time stop and re-operation of the RO apparatuses, that is, “a start/stop process” is performed in the cross-flow RO apparatuses for the purpose of physical rejection of fouling in addition to chemical cleaning.

As having an effect of the start/stop process causing physical fouling to be detached, “release of consolidation of membrane contaminants by stop the apparatuses, and flushing at the time of starting the apparatuses (the release of consolidation on the membrane surface is facilitated by change in the membrane-surface effective pressure at the time of transition from stop to start being large)” and “suck-back (backwash due to occurrence of osmotic pressure at the time of stop)” are exemplified. In addition, since the start/stop process secondarily occurs in normal water passing treatment (for example, change in the number of apparatuses to perform operation accompanying fluctuation in the flow rate of permeated water), the process is superior in being able to reject physical fouling without stopping the water passing treatment and without using chemicals.

Whether or not to execute the start/stop process is determined based on whether or not “the membrane performance recovery effect (for example, the amount of reduction in power consumption) by the start/stop process” is 0 or more, or whether or not “costs incurred by the start/stop process (for example, the amount of increase in consumption power accompanying a flushing step and activation of pumps) are exceeded. When this is satisfied, it is good to repeat the start/stop process as far as an abnormality in the desalting rate is not detected.

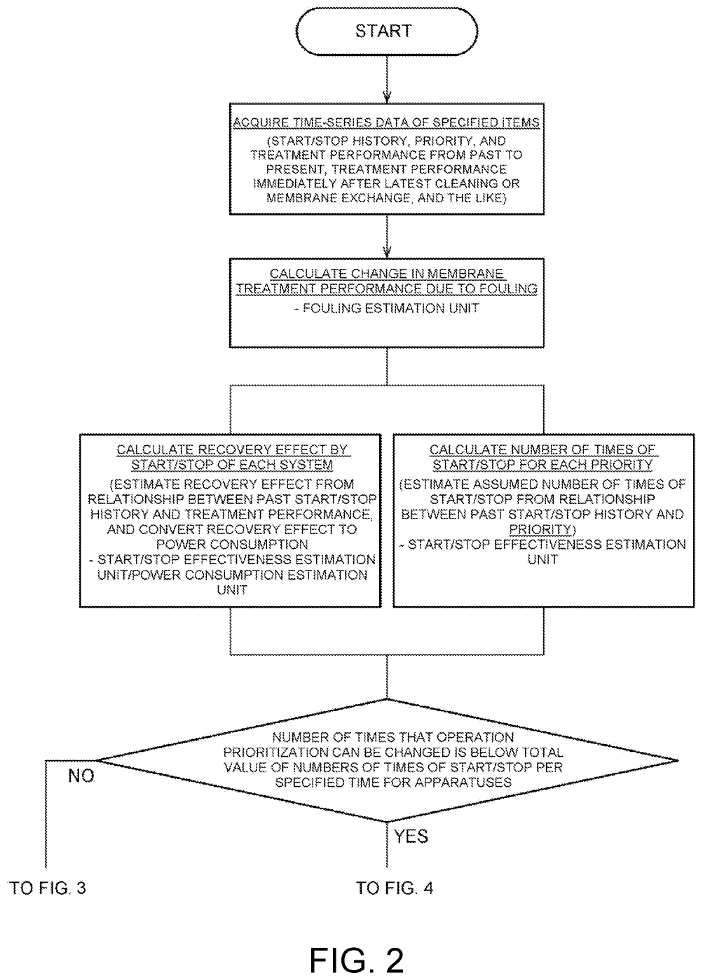

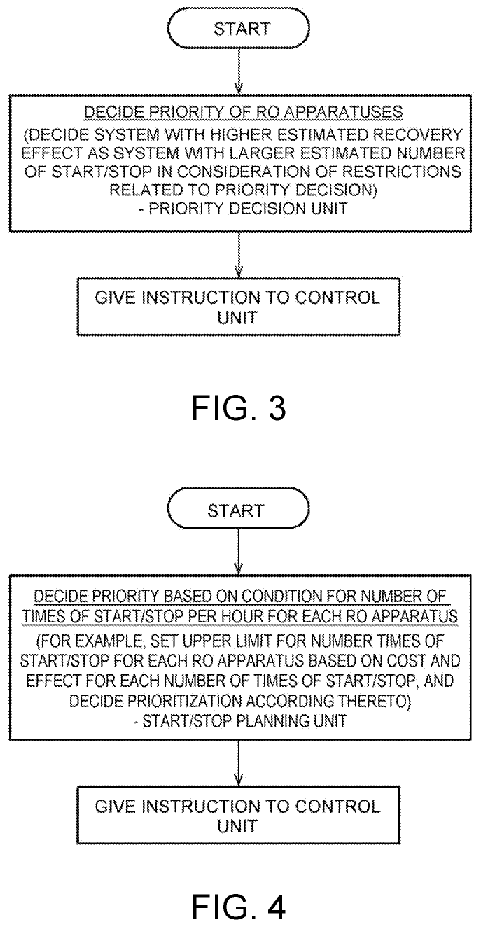

Specifically, as shown in FIGS. 2 to 4, from a relationship between a past start/stop history and membrane treatment performance history of each of RO apparatuses to be used, “membrane treatment performance expected to be recovered by the start/stop process”, in change from “membrane treatment performance immediately after the latest cleaning or membrane exchange” to “membrane treatment performance at a current time point”, is calculated, and then, “the number of times of start/stop per specified time” with a high effectiveness is decided from “a recovery effect for each number of times of start/stop per specified time (for example, within the past twenty-four hours)”, and “a membrane performance recovery effect by the start/stop process (for example, in water supply pressure and power consumption) at that time.

When start/stop of a certain RO apparatus is repeated, the recovery effect gradually decreases. Therefore, the recovery effect of each apparatus is calculated periodically (for example, every three hours), and operation priority is decided such that as large a number of times of start/stop as possible is assigned to a system with a high recovery effect.

Since physical fouling has a property of being more consolidated as time of sedimentation on the membrane surface is prolonged, “the membrane performance recovery effect by the start/stop process” gradually decreases. Since power consumption of each membrane apparatus increases only during time of performing operation, leaving “the membrane treatment performance expected to be recovered by the start/stop process”, detection and execution of the start/stop process at an early stage leads to significant reduction in power consumption and the number of times of cleaning per amount of permeated water.

In the present embodiment, in a system in which a plurality of RO apparatuses are arranged in parallel as described above, operation priority is decided. Especially, based on histories of starts/stops performed in an operation plan, the operation priority of the RO apparatuses is decided.

If an upper limit is set for the number of times of changing the operation priority, and “the number of times of start/stop per specified time” for each RO apparatus cannot be satisfied (for example, an operation of an operator giving an instruction to perform operation prioritization twice a day is decided), operation priority is decided such that as large a number of times of start/stop as possible is assigned to a system with a high recovery effect.

If “the number of times of start/stop per specified time” for each RO apparatus is satisfied, “membrane treatment performance capable of being recovered by the start/stop process” is detected at an early stage, and operation priority is decided so that the start/stop process is executed at an early stage.

As time during which operation of each RO apparatus is stopped by the start/stop process, 5 minutes or more, for example, 5 to 360 minutes are preferred, but the time is not limited thereto. If the stop time is shorter than 5 minutes, the membrane treatment performance recovery effect of the RO apparatus may be insufficient. Here, whether the membrane treatment performance has recovered or not is determined by whether “energy (power consumption, feed-water pressure) required per amount of permeated water after start/stop” is below “energy (power consumption, feed-water pressure) required per amount of permeated water before start/stop” or not.

If there is “membrane treatment performance not capable of being recovered by the start/stop process” in change from “the membrane treatment performance immediately after the latest cleaning or membrane exchange” to “the membrane treatment performance at current time point”, it is coped with by implementing another cleaning method (for example, chemical cleaning or flushing using chemicals or treated water). It is possible to, by planning a start/stop process in consideration of histories of start/stop operations performed in the operation plan, reduce the number of times of treatment related to fouling rejection and efficiently reject fouling, in comparison with PTL1 in which blow treatment is intentionally performed.

For the RO system, an operation plan is specified according to an amount of water to be generated, and the like, and information about the number of RO apparatuses to be operated at each time point is included in the operation plan.

The control system described above has the following functional units.

### <Control Unit>

The control unit controls operation and stop of a filtration apparatus by controlling a valve, a pump and the like.

The start/stop process includes operation of closing a flow path on the permeated water side and operation of reducing the flow rate of feed water.

### <Measurement Unit Measuring Feed-Water Information>

For example, pH, feed water pressure, and a feed water flow rate are measured.

### <Measurement Unit Measuring Membrane Treatment Performance>

For example, feed-water pressure, permeated water pressure, brine pressure, a feed-water flow rate, a permeated water flow rate, a brine flow rate, water temperature, feed-water conductivity, and treated water conductivity are measured.

### <Acquisition Unit Acquiring Pump State>

For example, frequency, output current, output voltage, power consumption, and exit pressure are acquired.

### <Recording Unit Recording Apparatus Information>

For example, a membrane area, the number of vessels, and a membrane configuration are recorded.

### <Storage Unit Storing Maintenance Histories>

Membrane treatment performance immediately after the latest cleaning or membrane exchange (for example, feed-water pressure, inter-membrane differential pressure, and a flux) is stored.

### <Storage Unit Storing Start/Stop Process History>

Both of histories of performing start/stop according to a water treatment operation plan and histories of intentionally performing the start/stop process for SS rejection are stored.

### <Storage Unit Recording Priority History>

A history of priority specified from the control unit is stored.

### <Calculation Unit Calculating Membrane Treatment Performance>

For example, inter-membrane differential pressure and a flux are calculated.

### <Power Consumption Estimation Unit>

When power consumption is not continuously measured, the power consumption is estimated from measured values (for example, feed-water pressure and a feed-water flow rate, and the like).

### <Fouling Estimation Unit>

An amount of change in membrane treatment performance due to fouling is calculated by excluding, from treatment performance immediately after the latest cleaning or membrane exchange, influence of operation conditions (for example, inlet water pressure, a treated water flow rate, and temperature) in a difference corresponding to reduction in the treatment performance due to influence of operation having been continued.

Properties of fouling are classified. For example, by calculating membrane treatment performance expected to be recovered by the start/stop process, in an amount of change in membrane treatment performance due to fouling, membrane treatment performance not capable of being recovered by the start/stop process is detected.

### <Start/Stop Effectiveness Estimation Unit>

For each RO apparatus, a membrane treatment performance recovery effect expected due to the start/stop process, that is, start/stop effectiveness is estimated. This is because whether start/stop is effective for recovery of membrane treatment performance or not differs depending on RO apparatuses.

The start/stop effectiveness for each RO apparatus is estimated from a relationship between its past start/stop history and membrane treatment performance history (for example, within one year). For example, by referring to the number of starts/stops performed within a predetermined period and changes in membrane treatment performance before and after the starts/stops, a degree of recovery of treatment performance by the starts/stops is calculated.

### <Start/Stop Process Planning Unit>

Timings of the start/stop process in the future are planned based on the start/stop histories. An RO apparatus that has not started/stopped within a predetermined period is caused to start/stop.

The number of times of start/stop is decided based on an estimation result of the start/stop effectiveness estimation unit. The number of times of start/stop is decided so that a number-of-times-of-start/stop effect to be an indicator of recovery efficiency is high. (For example, when there is no difference between five times of start/stop and four times of start/stop within 24 hours, four times is selected.)

### <Priority Decision Unit>

Priority of RO apparatuses to be caused to perform the start/stop process is decided based on the start/stop histories of the RO apparatuses.

An RO apparatus with a higher start/stop effectiveness is prioritized higher.

Furthermore, an RO apparatus in which the exit pressure or power consumption of the high pressure pump acquired by the pump state acquisition unit is larger is prioritized higher.

The present invention has been described in detail using specific aspects. It is, however, apparent to one skilled in the art that various changes are possible without departing from the intension and scope of the present invention.

This application is based on Japanese Patent Application 2021-030480 filed on Feb. 26, 2021, the disclosure of which is hereby incorporated by reference thereto in its entirety.

### REFERENCE SIGNS LIST

21-24 Pump
41 to 44 RO apparatus
57 Cleaning water tank

1. A method for controlling an RO system, the RO system comprising a plurality of RO apparatuses arranged in parallel and a control unit controlling a start/stop process, the start/stop process including an operation process and a stop process for the RO apparatuses, wherein
control is performed so that the number of times of start/stop is larger for an RO apparatus that easily recovers treatability by start/stop.

2. The method for controlling the RO system according to claim 1, wherein start/stop process histories of the RO apparatuses are stored; and
priority of RO apparatuses to be caused to operate, among the RO apparatuses, is decided based on the start/stop process histories.

3. The method for controlling the RO system according to claim 2, wherein membrane treatment performance histories of the RO apparatuses are stored in association with the start/stop process histories of the RO apparatuses; and
a degree of recovery of membrane treatment performance expected due to the start/stop process is estimated for each of the RO apparatuses, based on the start/stop process histories and the membrane treatment performance histories; and
an RO apparatus in which the degree of recovery expected due to the start/stop process is higher, among the RO apparatuses, is decided to be prioritized higher.

4. The method for controlling the RO system according to claim 3, wherein exit pressure or power consumption of a feed-water pump is measured, the feed-water pump feeding water to the RO apparatuses; and
an RO apparatus in which the exit pressure or the power consumption is higher, among the RO apparatuses, is decided to be prioritized higher.

5. The method for controlling the RO system according to claim 3,
wherein the number of times of the start/stop process during operation is decided based on a result of the estimation of start/stop effectiveness; and
the number of times of start/stop within a predetermined time is decided so that a number-of-times-of-start/stop effect is higher.

6. The method for controlling the RO system according to claim 1,
wherein membrane treatment performance of each of the RO apparatuses at a current time point is measured; and
priority of the RO apparatuses is decided based on the membrane treatment performance at the current time point.

7. A control program for controlling a water treatment system, the water treatment system comprising a plurality of RO apparatuses arranged in parallel;
the program causing a computer to execute:
a control instruction to control a start/stop process, the start/stop process including an operation process and a stop process for the RO apparatuses;
a storage instruction to store start/stop process histories of the RO apparatuses; and
a priority decision instruction to decide priority RO apparatuses to be caused to operate, among the RO apparatuses, based on the start/stop process histories.
